(19) United States
(12) Patent Application Publication
(10) Pub. No.: US 2013/0046550 A1
(43) Pub. Date: Feb. 21, 2013

(54) Tracking Status of Service Providers Across Plural Provider Practices

(71) Applicant: Roy Schoenberg, Boston, MA (US)

(72) Inventor: Roy Schoenberg, Boston, MA (US)

(73) Assignee: American Well Corporation

(21) Appl. No.: 13/211,428

(22) Filed: Aug. 17, 2011

(51) Int. Cl. G06Q 50/00

(52) U.S. Cl. 705/2

(57) ABSTRACT

A computer-implemented method includes identifying, by one or more computers, information pertaining to provider practices that a service provided is enrolled in, including status information of the service provider in the provider practices and information specifying consumers waiting for the service provider in waiting rooms of the provider practices; and generating, by the one or more computers, a graphical user interface for display of the information pertaining to the provider practices, and with the graphical user interface when rendered on a display device rendering, for a provider practice: a visual representation of status information of the service provider in the provider practice; and a visual representation of information specifying consumers waiting for the service provider in a waiting room of the provider practice.

### BACKGROUND

Systems have been developed to connect consumers and their providers over the Internet and the World Wide Web. Some systems use e-mail messaging and web-based forms to increase the level of connectivity between a member of a health plan and an assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in U.S. Pat. No. 7,590,550, which is incorporated herein by reference.

### SUMMARY

In one aspect of the present disclosure, a computer-implemented method includes identifying, by one or more computers, information pertaining to provider practices that a service provided is enrolled in, including status information of the service provider in the provider practices and information specifying consumers waiting for the service provider in waiting rooms of the provider practices; and generating, by the one or more computers, a graphical user interface for display of the information pertaining to the provider practices, and with the graphical user interface when rendered on a display device rendering, for a provider practice: a visual representation of status information of the service provider in the provider practice; and a visual representation of information specifying consumers waiting for the service provider in a waiting room of the provider practice.

These and other embodiments can each optionally include one or more of the following features. In some embodiments, the method includes receiving, by the one or more computers, an update to the information pertaining to the provider practices; and updating the portions of the graphical user interface with the update to the information. In other embodiments, the method includes receiving information specifying operational rules for the service provider in the provider practices. In still other embodiments, the method includes detecting a change in the status information of the service provider in the provider practice; and updating the status information in the visual representation of the status information based on the detected change.

In some embodiments, the method includes detecting a change in the information specifying the consumers waiting for the service provider in the waiting room of the provider practice; and updating the visual representation of the information specifying the consumers waiting for the service provider based on the detected change. In other embodiments, the method includes tracking, by the one or more computers, the status information of the service provider in the provider practices and the information specifying consumers waiting for the service provider in waiting rooms of the provider practices; and detecting, based on tracking, one or more changes in the status information of the service provider in the provider practices and the information specifying consumers waiting for the service provider in waiting rooms of the provider practices.

Other embodiments of these aspects include corresponding systems, apparatus, and computer programs, configured to perform the actions of the methods, e.g., encoded on computer storage devices.

### DESCRIPTION OF DRAWINGS

FIG. 1 is a diagrammatic view of a system for aggregating availability status information.

FIG. 2 depicts a process for aggregating availability status information.

FIG. 3 depicts a process for generating visual representations of aggregated availability status information.

FIG. 4 is a graphical user interface that when rendered on a display device renders a visual representation of aggregated availability status information.

FIG. 5 is a graphical user interface that when rendered on a display device renders a visual representation of status information for a service provider across multiple provider practices.

FIG. 6 depicts a process for generating status information for a service provider across multiple provider practices.

FIG. 7 is a block diagram of a computer (computer system) showing exemplary components that can be used for the brokerage system and/or client systems.

### DETAILED DESCRIPTION

Described below are techniques for aggregating (e.g., collectively tracking) availability status information received from plural brokerage services running on plural, different brokerage systems. As described in U.S. Pat. No. 7,590,550, a brokerage system implements a brokerage service to track real-time availability status information (e.g., information indicative of availability of service providers) and to broker interactions between available service providers and consumers of services. For example, an entity for a provider practice installs the brokerage service on a server used by the provider practice to implement a brokerage system for the provider practice. The provider practice's brokerage system tracks availability of the service providers associated with the provider practice (e.g., availability of physicians associated with a doctor's office). As used herein, a provider practice includes devices configured to implement services offered through the provider practice.

The system collects the availability status information from the plural, different provider practices running the brokerage service. Using the collected availability status information, the system determines which service providers from which provider practices are available for real-time consultations with consumers, for example, by aggregating together the collected availability status information. The system generates a resource from which the aggregated availability status information is accessed and viewed by a consumer. The resource includes, for example, a web page, a document, a graphical user interface, and so forth. For example, the system generates a web page that displays a visual representation of the aggregated availability status information and is accessible to a consumer from a uniform resource location (“URL”).

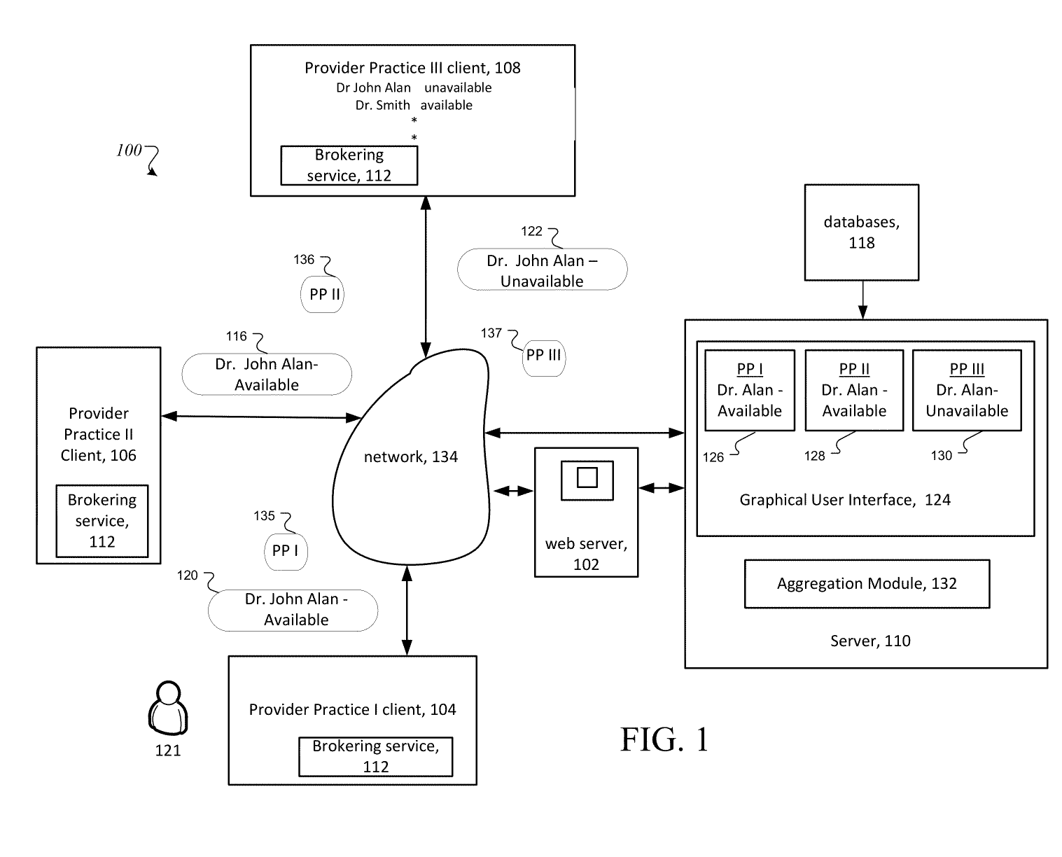

FIG. 1 shows an example system 100 for aggregating availability status information. System 100 includes a computerized system or server 110 and client devices 104, 106, 108. Client devices 104, 106, 108 include any combination of mobile devices, PDAs, cellular phones, portable or desktop computer systems, and so forth. Client devices 104, 106, 108 are used by various provider practices (“PP”) and are configured to run brokering service 112 to track availability of service providers associated with the practice. Client devices 104, 106 and 108 are used by corresponding provider practices (“provider practice I”), and (“provider practice II”) (“provider practice III”).

Using brokerage service 112, client devices 104, 106, 108 generate availability status information 116, 120, 122 for the respective provider practices, including, e.g., service provider 121. For example, through execution of brokerage service 112, client device 104 generates availability status information 120 specifying that service provider 121, named “Dr. John Alan,” is available for a real-time consultation with a consumer. Dr. John Alan is a service provider associated with provider practices I, II, III. Client device 104 sends availability status information 120 to server 110, e.g., via a message that includes availability status information 120.

Additionally, through execution of brokerage service 112, client device 106 generates availability status information 116 specifying that service provider “Dr. John Alan” is available for a real-time consultation with a consumer in provider practice II. Additionally, through execution of brokerage service 112, client device 108 generates availability status information 122 specifying that service provider “Dr. John Alan” is unavailable for a real-time consultation with a consumer in provider practice III.

Client devices 104, 106, 108 send availability status information 116, 120, 122 to server 110 over a network 134, e.g., the Internet or other types of networks. Server 110 saves availability status information 116, 120, 122 in database 118. Client devices 104, 106, 108 also send provider practice information 135, 136, 137 (e.g., PP I, PP II, PP III) to server 110. Provider practice information 135, 136, 137 specifies a name (or other identifying information) of the provider practice sending availability status information 116, 120, 122.

Server 110 receives availability status information 116, 120, 122 and provider practice information 135, 136, 137, and tags availability status information 116, 120, 122 with the provider practice information 135, 136, 137. Server 110 uses the tags to query database 118 for availability status information associated with particular provider practices (e.g., provider practices matching a requested list of provider practices).

For example, server 110 tags availability status information 120 with information 135 specifying that availability status information 120 is associated with the first provider practice (“PP I”). Server 110 tags availability status information 116 with information 136 specifying that availability status information 116 is associated with the second provider practice (“PP II”). Server 110 tags availability status information 122 with information 137 specifying that availability status information 122 is associated with the third provider practice (“PP III”).

Server 110 also includes one or more processes such as aggregation module 132. Aggregation module 132 queries database 118 for availability status information, for example, associated with certain provider practices. Aggregation module 132 sends to database 118 a query for availability status information associated with certain provider practices. Database 118 retrieves availability status information that is tagged with provider practice information corresponding to the requested provider practices. Database 118 sends this determined availability status information and tags to aggregation module 132.

Using availability status information 116, 120, 122 and tags associated with PP I 135, PP II 136, and PPP III 137, aggregation module 132 generates graphical user interface 124. The graphical user interface 124 renders on a display device visual representations 126, 128, 130 of availability status information 116, 120, 122 associated with PP I 135, PP II 136, and PPP III 137. These visual representations 126, 128, 130 are also be referred to herein as “silos” of availability status information 116, 120, 122 for particular provider practices.

Server 110 operates as a service running on web server 102. Using web server 102, a client device used by a consumer accesses graphical user interface 124, for example, by accessing a URL for graphical user interface 124.

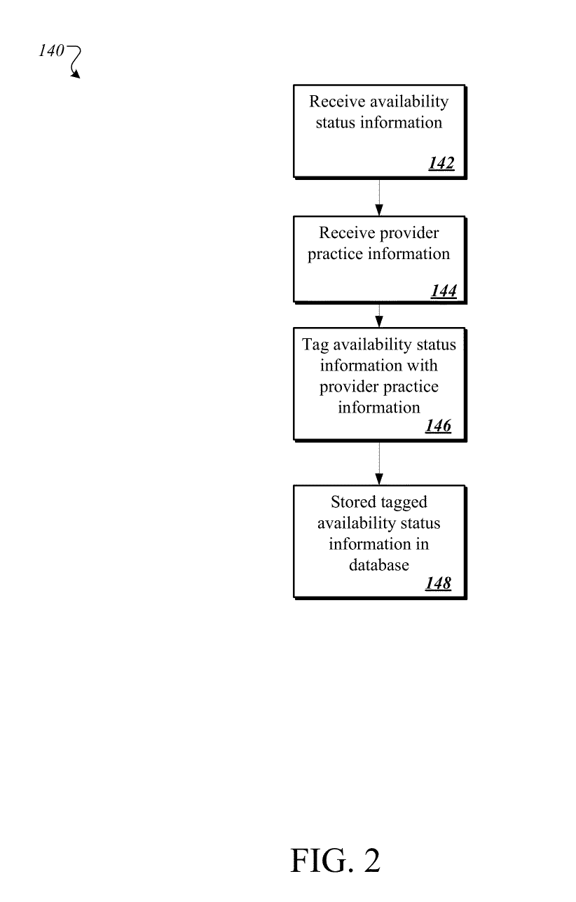

FIG. 2 depicts a process 140 for aggregating availability status information 116, 120, 122. In operation, server 110 receives (142) availability status information 116, 120, 122, e.g., from client devices 116, 120, 122. Server 110 also receives (144) from client devices 116, 120, 122 provider practice information 135, 136, 137. Aggregation module 132 tags (146) availability status information 116, 120, 122 with provider practice information 135, 136, 137. For example, availability status information 120 is tagged with provider practice information 135 for PP I. Availability status information 116 is tagged with provider practice information 136 for PP II. Availability status information 122 is tagged with provider practice information 137 for PP III. Server 110 stores (148) in database 118 the tagged availability status information.

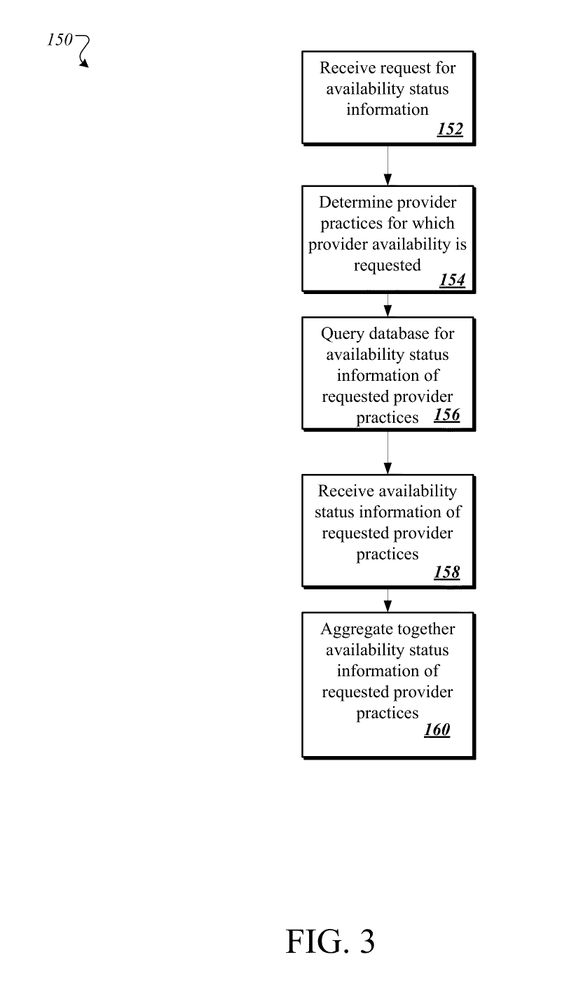

FIG. 3 depicts a process 150 for generating visual representations 126, 128, 130 of aggregated availability status information. In operation, server 110 receives (152) a request (not shown) for availability status information, e.g., to be displayed in graphical user interface 124. For example, a consumer may request graphical user interface 124 by using a web browser to access a URL for graphical user interface 124.

Server 110 generates plural graphical user interfaces to display provider availability for different provider practices and/or subscribers of availability status information. Generally, a subscriber is an entity that receives aggregated availability status information for a fee.

For example, a subscriber is an insurance company. Two different insurance companies subscribe to the aggregated availability status information, namely insurance company A and insurance company B. Insurance company A provides its consumers with access to PP I, PP II, PP III. Aggregation module 132 generates a listing of the provider practices for insurance company A. Insurance company B provides its consumers with access to PP II, PP III. Aggregation module 132 also generates a listing of the provider practices for insurance company B.

For insurance company A, aggregation module 132 generates a graphical user interface (e.g., graphical user interface 124) that displays silos for PP I, PP II, PP III. Graphical user interface 124 for insurance company A is associated with a unique URL, e.g., “http://insuranceA/availability.” For insurance company B, aggregation module 132 generates another, different graphical user interface displaying silos for PP II, PP III. The graphical user interface for insurance company B is also associated with a unique URL, e.g., “http://insuranceB/availability.”

Still referring to FIG. 3, server 110 determines (154) the provider practices for which availability status information is requested. The consumer requests the availability status information for provider practices of insurance company A, by through graphical user interface 124, which is associated with insurance company A. The request received by server 110 includes the URL for graphical user interface 124. Using the contents of the URL, server 110 identifies that the request is for provider practices of insurance company A. Server 110 retrieves from database 118 the listing of provider practices for insurance company A, namely, PP I, PP II and PP III.

Aggregation module 132 queries (156) database 118 for availability status information 116, 120, 122 associated with the requested provider practices by requesting availability status information 116, 120, 122 that is tagged with provider practice information 135, 136, 137. Aggregation module 132 receives (158) availability status information 116, 120, 122. Aggregation module 132 also receives (not shown) provider practice information 135, 136, 137. Using retrieved availability status information 116, 120, 122 and provider practice information 135, 136, 137, aggregation module 132 aggregates (160) availability status information 116, 120, 122. Server 110 provides the aggregated availability status information by generating graphical user interface 124 having silos 126, 128, 130.

In a variation of FIG. 3, server 110 sends client devices 104, 106, 108 requests for availability status information 116, 120, 122, e.g., following receipt of a request for graphical user interface 124. Aggregation module 132 receives availability status information 116, 120, 122 and updates silos 126, 128, 130 with availability status information 116, 120, 122. In still another variation, server 110 sends client devices 104, 106, 108 requests for availability status information 116, 120, 122, e.g., at pre-defined intervals.

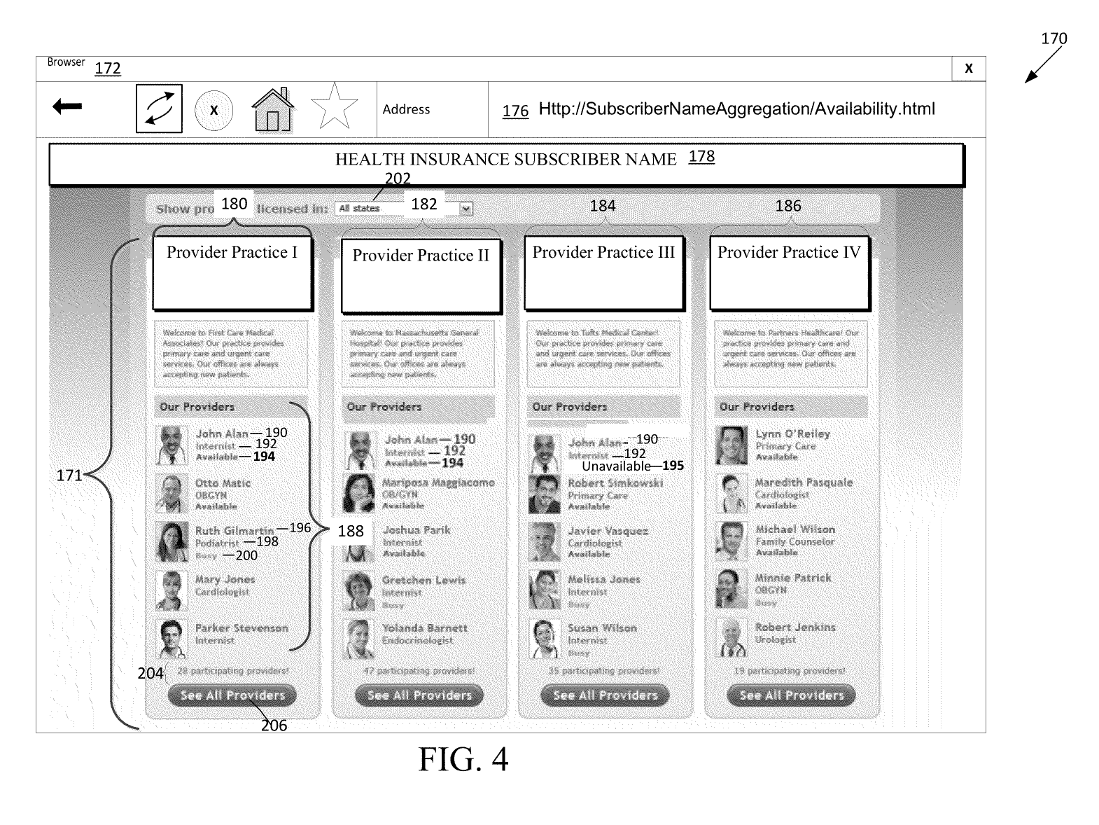

FIG. 4 depicts graphical user interface 170 that when rendered on a display device (e.g., via web browser 172) renders visual representation 171 of aggregated availability status information. Web browser 172 includes portion 176 that displays the virtual location (e.g., URL of http://subscribernameaggregation/availability.html) of graphical user interface 170. Graphical user interface 170 also includes portion 178 that displays information indicative of a name of a subscriber to the aggregated availability status information provided by server 110. The subscriber name may be the name of a legal entity such as a corporation, an insurance company, an educational institute, and so forth. Graphical user interface 170 includes silos 180, 182, 184, 186.

Silos 180, 182, 184, 186 provide availability status information for plural, different provider practices. Silo 180 provides availability status information from provider practice I. Silo 182 provides availability status information for provider practice II. Silo 184 provides availability status information for provider practice III. Silo 186 provides availability status information for provider practice IV. Aggregated availability status information includes the availability status information in silos 180, 182, 184, 186.

Silo 180 includes portion 188. Portion 188 provides a listing of service providers associated with provider practice I and availability status indicators for the service providers. An availability status indicator is information specifying an availability status of a service provider, including, for example, whether a service provider is available, busy, engaged with another consumer, and so forth. Portion 188 includes provider information 190 for service provider 121. Service provider A is associated with three, different provider practices, e.g., provider practices I-III.

Provider information 190 includes information specifying the name of a service provider. Portion 188 also includes service provider type information 192. Service provider type information 192 includes information specifying a type of service provider, for example, an internist, a gynecologist, a podiatrist, a cardiologist, a gastroenterologist, and so forth. Portion 188 also includes availability status indicator 194. Availability status indicator 194 indicates that the service provider associated with service provider information 190 is presently available for consultations with consumers.

Portion 188 of silo 180 also includes service provider information 196. Service provider information 196 includes identifying information for another service provider associated with provider practice I. Portion 188 also includes service provider type information 198. Service provider type information 198 includes information specifying the type of service provider that is associated with service provider information 196.

Portion 188 of silo 180 also includes availability status indicator 200. Available status indicator 200 displays information indicative of the availability status for the service provider associated with service provider information 196. Portion 188 of silo 180 also includes section 204. Section 204 displays information indicative of a number of service providers that are associated with provider practice I.

Silo 180 also includes button 206. Upon selection of button 206, for example, by a consumer viewing graphical user interface 170, server 110 is configured to display for the consumer a complete listing of all the service providers that are associated with provider practice I. Silos 182, 184, 186 include the same and/or similar types of information as silo 180.

Silos 182, 184 also include provider information 190 specifying the name of “John Alan,” and provider type information 192. Silo 182 includes availability status indicator 194, specifying that Dr. John Alan is available in provider practice II. Silo 184 includes availability status indicator 195, specifying that Dr. John Alan is unavailable in provider practice III.

Graphical user interface 170 also includes portion 202. Portion 202 may include a text box and/or other selectable area through which a consumer can specify certain criterion in which to view provider practices. For example, a consumer can use portion 202 to view provider practices associated with a particular subscriber in certain geographic locations or across all geographic locations. Geographic locations can be defined as different sovereign entities, such as countries, providences or states, for example or different licensing jurisdictions.

As previously described, service provider 121 is associated with provider practices I-III. Brokerage system 110 tracks availability status information 116, 120, 122 and/or login status information for service provider 121 across provider practices I-III. Brokerage system 110 also tracks waiting room information, e.g., information specifying a number of consumers waiting for service provider 121 in waiting rooms of provider practices I-III. Types of waiting rooms include virtual waiting rooms, waiting rooms in a physical office space, and so forth.

Brokerage system 110 tracks waiting room information for service provider 121 using various techniques, including, e.g., receiving waiting room information from client devices 104, 106, 108, providing virtual waiting rooms through brokerage system 110, and so forth. Using brokerage system 110, service provider 121 tracks and/or views availability status information 116, 120, 122, login status information, and/or waiting room information.

Through brokerage system 110, service provider 121 logs into accounts for provider practices I-III to specify availability for consultations in provider practices I-III. Service provider 121 also enrolls in provider practices I-III using brokerage system 110, for example, by specifying an affiliation with a provider practice, through information specifying that the service provider is authorized to practice in a provider practice, by specifying contact information for the service provider, and so forth.

For provider practices I-III, service provider 121 sends to brokerage system 110 with credentialing information, including, e.g., information specifying credentials to practice in provider practices I-III. Provider practices I-III are in different geographic locations, e.g., states. Service provider 121 inputs into brokerage system 110 credentialing information specifying license numbers for service provider 121 in the geographic states in which the provider practices are located.

Service provider 121 also inputs into brokerage system 110 information specifying operational rules for the provider practices with which the service provider is enrolled. The operational rules include information specifying times in which service provider 121 is available for consultations, pager numbers, telephone numbers, and other contact information. Brokerage system 110 stores in database 118 the operations rules and the credentialing information for provider practices I-III.

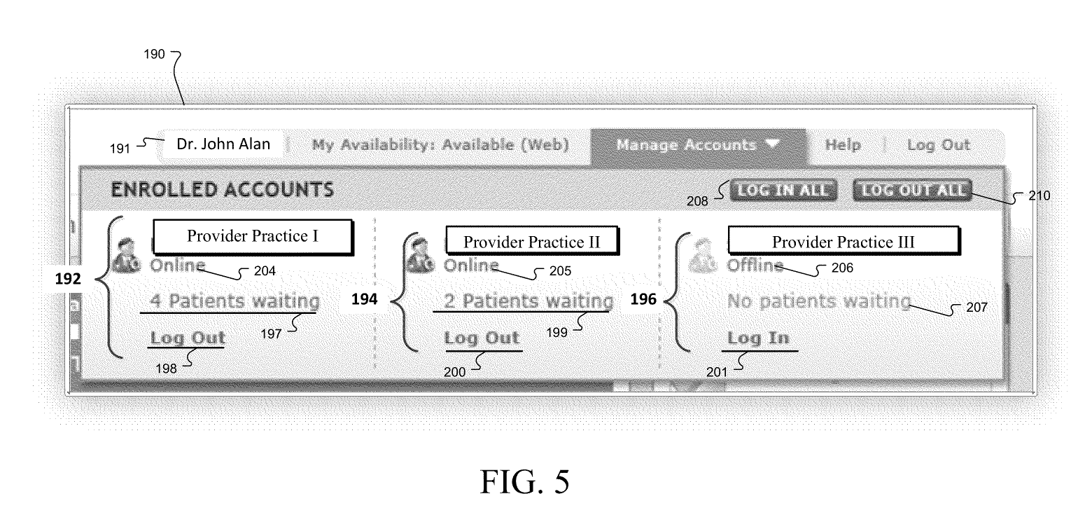

Referring to FIG. 5, brokerage system 110 generates graphical user interface 190. Graphical user interface 190 provides service provider 121 with information pertaining to provider practices I, II, III, in which service provider 121 is enrolled. Graphical user interface 190 provides service provider 121 with visual indications of status information (e.g., availability status information and/or login status information) in provider practices I-III and consumers that are in waiting rooms in provider practices I-III. Portion 191 of graphical user interface displays information specifying a name of service provider 121 for which information is displayed in graphical user interface 190.

Graphical user interface 190 includes portion 192 that depicts information relating to service provider 121 in provider practice I. Graphical user interface 190 also includes portion 194 that depicts information relating to service provider 121 in provider practice II. Portion 196 depicts status information relating to service provider 121 in provider practice III.

Portions 192, 194 and 196 of graphical user interface 190 each include an indicator 204, 205 and 206, respectively. As an exemplary one, indicator 204 displays login status information for service provider 121. Login status information includes information specifying that service provider 121 is either logged into (or logged out of) provider practice I. By logging into provider practice I, service provider 121 indicates an availability to consult with consumers seeking consultations through provider practice I.

Portion 192 of graphical user interface 190 also includes link 197. Link 197 displays waiting room information, including, e.g., information specifying a number of consumers waiting for service provider 121 in a waiting room of provider practice I. Link 197 is a selectable link, selection of which causes portion 192 of graphical user interface 190 to be updated with additional information for the consumers waiting in the waiting room of provider practice I for service provider 121.

Selection of link 197 enables service provider 121 to view information pertaining to the consumers in the waiting room, including, e.g., consumers name information, consumers health history information, consumers diagnosis information, and so forth. Portion 192 of graphical user interface 190 also includes link 198, selection of which causes service provider 121 to log out of provider practice I.

Portion 194 of graphical user interface 190 includes link 199. Link 199 displays information specifying a number of consumers waiting for service provider 121 in a waiting room of provider practice II. Link 199 is a selectable link, selection of which causes portion 194 of graphical user interface 190 to be updated with additional information for the consumers waiting in the waiting room of provider practice II for service provider 121. Portion 194 of graphical user interface 190 also includes link 200, selection of which causes service provider 121 to log out of provider practice II.

Portion 196 of graphical user interface 190 includes indicator 206. Indicator 206 displays information specifying that service provider 121 is logged out of provider practice III, e.g., by logging out of an account of service provider 121 that is associated with provider practice III. By logging out of provider practice III, service provider 121 indicates an unavailability to consult with consumers seeking consultations through provider practice III.

Portion 196 of graphical user interface 190 also includes waiting room information 207 specifying that no consumers are waiting for consultations with service provider 121 in provider practice III. Portion 196 of graphical user interface 190 also includes link 201, selection of which logs service provider 121 into provider practice III.

Graphical user interface 190 includes button 208, selection of which logs service provider 121 into all the provider practices in which service provider 121 is enrolled, e.g., provider practices I, II, III. Graphical user interface 190 includes button 210, selection of which logs service provider 121 out of all the provider practices in which service provider 121 is enrolled, e.g., provider practices I, II, III. As previously described, service provider 121 is logged into/out of provider practices I, II, III through accounts associated with service provider 121 in provider practices I, II, III.

Graphical user interface 190 is updated in real-time with updated status information for service provider 121 and updated waiting room information for each provider practice that service provider 121 is associated with and has requested to view. Using information sent from client devices 104, 106, 108 and/or from information tracked by brokerage system 110, brokerage system 110 detects changes in status information for service provider 121, e.g., as service provider 121 logs into and out of provider practices I, II, III. Using the detected changes in status information, service provider 121 updates portions 192, 194, 196 of graphical user interface 190 with indicators 204, 206 to specify a logged in status of service provider 121.

Additionally, brokerage system 110 detects changes in waiting room information for provider practices I, II, III, e.g., as consumers are removed from waiting rooms to consult with service provider 121, as consumers enter waiting rooms, and so forth. Brokerage system 110 detects the changes using information sent from client devices 104, 106, 108 and/or from information tracked by brokerage system 110. Using the detected changes in waiting room information, brokerage system 110 updates waiting room information 207 and links 197, 199 of graphical user interface 190.

A service provider may choose (e.g., through a graphical user interface) which provider practices are displayed in graphical user interface 190. For example, a service provider may be enrolled in seventy, different provider practices. However, the service provider may only want to view a subset of the enrolled provider practices in graphical user interface 190.

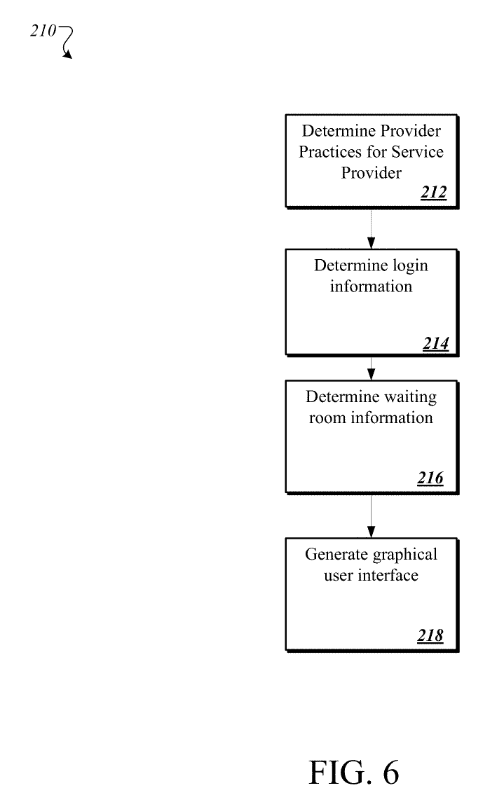

Referring to FIG. 6, brokerage system 110 implements process 210 to collect status information to display in graphical user interface 190. In operation, brokerage system 110 determines (212) provider practices I, II, III in which service provider 121 is enrolled. Using provider practice information 135, 136, 137, brokerage system 110 determines that service provider 121 is enrolled in provider practices I, II, III. Brokerage system 110 also determines (214) status information for service provider 121, e.g., based on availability status information 116, 120, 122. Status information also includes login status information. Brokerage system 110 also determines (216) waiting room information indicative of a number of consumers waiting for service provider 121 in a waiting room of a provider practice. Using the waiting room information and the login status information, brokerage system 110 generates (218) graphical user interface 190.

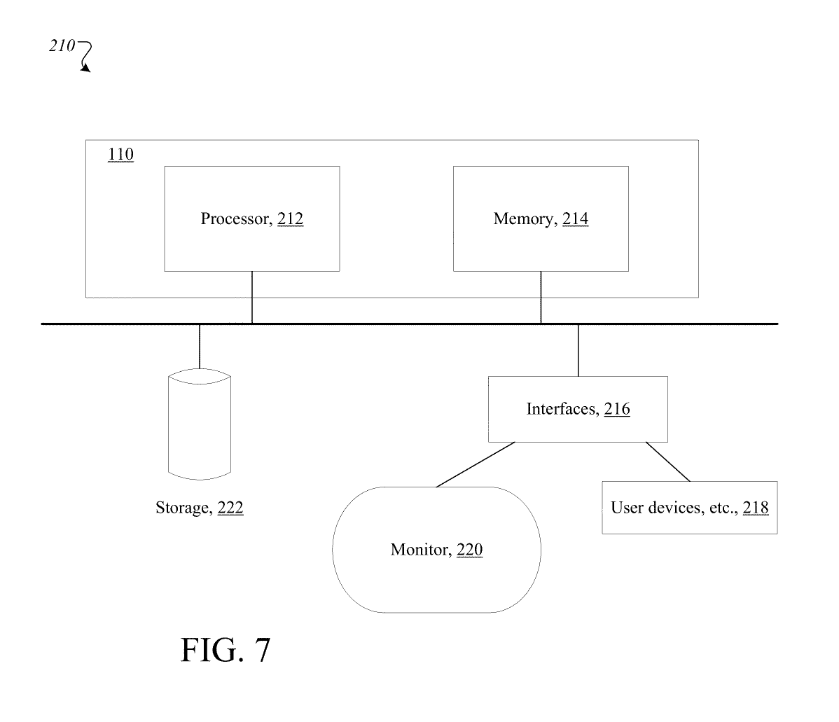

FIG. 7 is a block diagram of components 210 of the engagement brokerage system. User devices 218 can be any sort of computing device capable of taking input from a user and communicating over a network (not shown) with server 110 and/or with other client devices. For example, user device 218 can be a mobile device, a desktop computer, a laptop, a cell phone, a personal digital assistant (“PDA”), a server, an embedded computing system, a mobile device and so forth. User devices 218 include monitor 220, which renders visual representations of interface 216.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from user device 218 via interfaces 216, including, e.g., graphical user interfaces. Interfaces 216 can be any type of interface capable of receiving information over a network, such as an Ethernet interface, a wireless networking interface, a fiber-optic networking interface, a modem, and so forth. Server 110 also includes a processor 212 and memory 214. A bus system (not shown), including, for example, a data bus and a motherboard, can be used to establish and to control data communication between the components of server 110.

Processor 212 may include one or more microprocessors. Generally, processor 212 may include any appropriate processor and/or logic that is capable of receiving and storing data, and of communicating over a network (not shown). Memory 214 can include a hard drive and a random access memory storage device, such as a dynamic random access memory, machine-readable media, or other types of non-transitory machine-readable storage devices.

Components 210 also include storage device 222, which is configured to store information collected through the brokerage system during a service provider's consultation with a consumer. In another example, storage device 222 is also configured to receive information (e.g., a number of consumers waiting in a physical waiting room) from a physician's physical office and to integrate the information associated with the physical office into the brokerage system so that the brokerage system may access and may use the information associated with the physical office space.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Computer readable storage media are storage devices. Storage devices suitable for tangibly embodying computer program instructions and data include all forms of memory devices, including by way of example semiconductor memory devices, such as volatile RAM, or non-volatile memory devices such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprising:
identifying, by one or more computers, information pertaining to provider practices that a service provided is enrolled in, including status information of the service provider in the provider practices and information specifying consumers waiting for the service provider in waiting rooms of the provider practices; and
generating, by the one or more computers, a graphical user interface for display of the information pertaining to the provider practices, and with the graphical user interface when rendered on a display device rendering, for a provider practice:
a visual representation of status information of the service provider in the provider practice; and
a visual representation of information specifying consumers waiting for the service provider in a waiting room of the provider practice.

2. The computer-implemented method of claim 1, further comprising:
receiving, by the one or more computers, an update to the information pertaining to the provider practices; and
updating the portions of the graphical user interface with the update to the information.

3. The computer-implemented method of claim 1, further comprising:
receiving information specifying operational rules for the service provider in the provider practices.

4. The computer-implemented method of claim 1, further comprising:
detecting a change in the status information of the service provider in the provider practice; and
updating the status information in the visual representation of the status information based on the detected change.

5. The computer-implemented method of claim 1, further comprising:
detecting a change in the information specifying the consumers waiting for the service provider in the waiting room of the provider practice; and
updating the visual representation of the information specifying the consumers waiting for the service provider based on the detected change.

6. The computer-implemented method of claim 1, further comprising:
tracking, by the one or more computers, the status information of the service provider in the provider practices and the information specifying consumers waiting for the service provider in waiting rooms of the provider practices; and
detecting, based on tracking, one or more changes in the status information of the service provider in the provider practices and the information specifying consumers waiting for the service provider in waiting rooms of the provider practices.

7. A computer program product tangibly stored on a computer readable storage media, the computer program product comprising instructions for causing a processor to perform operations comprising:
identifying information pertaining to provider practices that a service provided is enrolled in, including status information of the service provider in the provider practices and information specifying consumers waiting for the service provider in waiting rooms of the provider practices; and
generating a graphical user interface for display of the information pertaining to the provider practices, and with the graphical user interface when rendered on a display device rendering, for a provider practice:
a visual representation of status information of the service provider in the provider practice; and
a visual representation of information specifying consumers waiting for the service provider in a waiting room of the provider practice.

8. The computer program product of claim 7, wherein the operations further comprise:
receiving an update to the information pertaining to the provider practices; and
updating the portions of the graphical user interface with the update to the information.

9. The computer program product of claim 7, wherein the operations further comprise:
receiving information specifying operational rules for the service provider in the provider practices.

10. The computer program product of claim 7, wherein the operations further comprise:
detecting a change in the status information of the service provider in the provider practice; and
updating the status information in the visual representation of the status information based on the detected change.

11. The computer program product of claim 7, wherein the operations further comprise:
detecting a change in the information specifying the consumers waiting for the service provider in the waiting room of the provider practice; and
updating the visual representation of the information specifying the consumers waiting for the service provider based on the detected change.

12. The computer program product of claim 7, wherein the operations further comprise:
tracking the status information of the service provider in the provider practices and the information specifying consumers waiting for the service provider in waiting rooms of the provider practices; and
detecting, based on tracking, one or more changes in the status information of the service provider in the provider practices and the information specifying consumers waiting for the service provider in waiting rooms of the provider practices.

13. An electronic system comprising:
a processor; and
a computer program product tangibly stored on a computer readable storage media, the computer program product comprising instructions for causing the processor to perform operations comprising:
identifying information pertaining to provider practices that a service provided is enrolled in, including status information of the service provider in the provider practices and information specifying consumers waiting for the service provider in waiting rooms of the provider practices; and
generating a graphical user interface for display of the information pertaining to the provider practices, and with the graphical user interface when rendered on a display device rendering, for a provider practice:
a visual representation of status information of the service provider in the provider practice; and
a visual representation of information specifying consumers waiting for the service provider in a waiting room of the provider practice.

14. The electronic system of claim 13, wherein the operations further comprise:
receiving an update to the information pertaining to the provider practices; and
updating the portions of the graphical user interface with the update to the information.

15. The electronic system of claim 13, wherein the operations further comprise:
receiving information specifying operational rules for the service provider in the provider practices.

16. The electronic system of claim 13, wherein the operations further comprise:
detecting a change in the status information of the service provider in the provider practice; and
updating the status information in the visual representation of the status information based on the detected change.

17. The electronic system of claim 13, wherein the operations further comprise:
detecting a change in the information specifying the consumers waiting for the service provider in the waiting room of the provider practice; and
updating the visual representation of the information specifying the consumers waiting for the service provider based on the detected change.

18. The electronic system of claim 13, wherein the operations further comprise:
tracking the status information of the service provider in the provider practices and the information specifying consumers waiting for the service provider in waiting rooms of the provider practices; and
detecting, based on tracking, one or more changes in the status information of the service provider in the provider practices and the information specifying consumers waiting for the service provider in waiting rooms of the provider practices.
